(19) United States
(12) Patent Application Publication
(10) Pub. No.: US 2011/0289404 A1
(43) Pub. Date: Nov. 24, 2011

(54) System and methods for document critique

(76) Inventors: Alexandra Fleur, Lakewood, CA (US); Ashley Nathaniel Bradford, Long Beach, CA (US)

(21) Appl. No.: 12/800,641

(22) Filed: May 19, 2010

(51) Int. Cl. G06F 17/24; G06F 3/048

(52) U.S. Cl. 715/255; 715/781

(57) ABSTRACT

A document application for critique a document, comprising a critique module for communication with an interface application for critique and viewing a document having a critique indicator within the document and a corresponding linked critique element in a margin of the document, is described herein.

### BACKGROUND

1. Field of Invention

The subject matter disclosed herein generally relates to document annotation, and more specifically to the critique of a document as well as document access, viewing, and sharing.

2. Related Art

With the advent of computers, a document is often thought of as a digital representation of information designed with the capacity and intent to communicate. Such digital representations may be created and viewed with a computer having a monitor, a laptop, a personal digital assistant (PDA), and similar type electronic devices.

With a desktop application such as Word, editing of a document on the electronic device may be accomplished with word processing tools such a cut-and-paste, delete, underline, etc. If further editing by someone other than the author is required, the document may be attached to an email, for example, and sent to a reviewer who may edit the document using a desktop application editing tool such as track change. The track change tool permits the reviewer's edits, and/or remarks/comments to be viewed by the author of the document once the document is sent back to the author.

As shown in FIG. 1, existing technology such as the track change edit tool permits among other things, text additions and deletions that alter the text of the document, as well as the ability to insert a comment designator. Edits and comment designators are connected with a track line to corresponding edits and comments disposed within a right-hand margin of the document. In this regard, the comments and edits are embedded or directly connected to the document such that the comments and edits correspondingly move along as the document is scrolled up or down. As the comment and edits are embedded in the document, placement of edits in the side (right) margin of the document reduces the margin width of the not just the page upon which the edit took place, but the entire document regardless of whether any edits took place on other parts of the document such that the appearance and readability of the entire document is altered dramatically.

Although not shown in FIG. 1, in addition to the embedded edits within the right margin of the document, the track change tool includes an optional vertical or horizontal reviewing pane for summary and review of track change edits.

The vertical and horizontal reviewing panes each provide a summary of insertions, deletions, moves, formatting, and comments, as well as a listing of the main document changes and comments including type of edit, author of edit, and date of edit. Changes to the listings of the vertical and horizontal reviewing pane can only be made through change's in the document. In other words, as an editing change occurs within the document a corresponding change occurs within the vertical or horizontal reviewing pane. Furthermore, scrolling of the document does not cause a corresponding movement of either the vertical or horizontal reviewing pane.

Footnotes in known editing applications, similar to the edits and comments mentioned above, are embedded within the document, albeit at the bottom of the document. As such, removal from view of an edit, comment, or footnote results in its permanent removal, that is, the deletion of the edit, comment, or footnote from the document.

Network connectivity, the Internet, and World Wide Web along with associated websites make document availability, posting, and sharing commonplace. Such online availability potentially provides the opportunity for a document to be accessed by many individuals located at great distances from each other. In this regard, educational institutions, corporate entities, and social groups or clubs along with the often geographically dispersed corresponding student body, employee pool, and membership base may be linked via online connectivity to save, post, and access documents facilitated by remote network servers.

To date, such document edit tools provided by online entities such as Googledocs are generally limited to those mentioned above. Despite providing some level of document sharing and word-processing capability, current desktop and online editing applications are limited in their tool options and lack the ability to offer rich-media critique of documents for review and sharing. Accordingly, there exists a need for a relatively more robust and easy to use system and method for the access, viewing, critique, and sharing of documents.

### SUMMARY

For purposes of summarizing the disclosure, exemplary embodiments of systems and methods for document access, viewing, critique, and sharing have been described herein.

In one embodiment, a document application for the critique of a document includes a critique module for communication with an interface application for critique and viewing a document having a critique indicator within the document and a correspondingly linked critique element along a margin of the document.

In another embodiment, a system for display and critique of a document includes a storage device for storage of a document; a processing element having a processing program and access to the storage device; and a processing-readable medium having executable instructions thereon to direct the processing system when used by the processing element to display the document for critique. The document has a critique indicator within the document and a correspondingly linked critique element along a margin of the document.

In still another embodiment, a computer-readable medium having computer executable instructions thereon to direct a processing system when used by a processing component for performing a method includes displaying a document for critique, wherein the document includes a critique indicator within the document and a correspondingly linked critique element along a margin of the document

These and other features and advantages of the present invention will be more readily apparent from the detailed description of the embodiments set forth below taken in conjunction with the accompanying drawings.

### BRIEF DESCRIPTION OF THE DRAWINGS

FIG. 1 shows a document edited with a known technology such as a track change application with edits embedded in the document and in the right margin of the document.

FIG. 2 shows a block diagram of a system configured to facilitate access, viewing, critique, and sharing of a document over a network in accordance with one embodiment.

FIG. 3 shows the use of an interface application in communication with a critique module of a document application to access and display (view) a document for critique and a corresponding critique viewing area each displayed in a separate window of a horizontal single-frame split screen in accordance with one embodiment.

FIGS. 4A-4C show a critique pallet having a drop down menu that includes selectable critique types including a proofing tools, criticisms and praises, for the insertion of critique marks into the document in accordance with one embodiment.

FIG. 5 shows a video/audio record mechanism for the insertion of audio and/or video into the document in accordance with one embodiment.

FIG. 6 shows additional features of a critique module including critique indicators within the document as a visual cue for the presence of linked critique elements, one or more paragraph tab summary makers, “hot spot” areas, one or more scroll bars, and one or more filters such as a critique type filter and a critiquer filter, as well as a workpile tool, and a document version file in accordance with one embodiment.

FIG. 7 shows a pop-up window of the workpile tool in accordance with one embodiment.

FIGS. 8A and 8B show the use of an interface application in communication with a critique module of a document application to access and display (view) a document for critique and a corresponding critique viewing area each displayed in a separate window of a vertical single-frame split screen in accordance with one embodiment.

FIG. 9 shows a counting and conversion mechanism that provides for dynamic placement and analytics in accordance with one embodiment.

FIG. 10 is a block diagram of a computer system suitable for implementing one or more embodiments.

Exemplary embodiments are best understood by referring to the detailed description that follows. It should be appreciated that like reference numerals are used to identify like elements illustrated in one or more of the figures, wherein showings therein are for purposes of illustrating exemplary embodiments and not for purposes of limiting the same.

### DETAILED DESCRIPTION

Embodiments described herein relate to a relatively more robust and easy to use system and method for, among other things, the critique of documents. As indicated above, such document critique may find application in various areas including, but not limited to, person-to-person interactions, as well as online connectivity of educational institutions, corporate entities, and social groups or clubs along with the often geographically dispersed corresponding student body, employee pool, and membership base that permits documents online to be accessed, viewed, saved, posted, and critiqued. In this regard, the system and methods for document critique described herein may provide a pedagogical teaching tool.

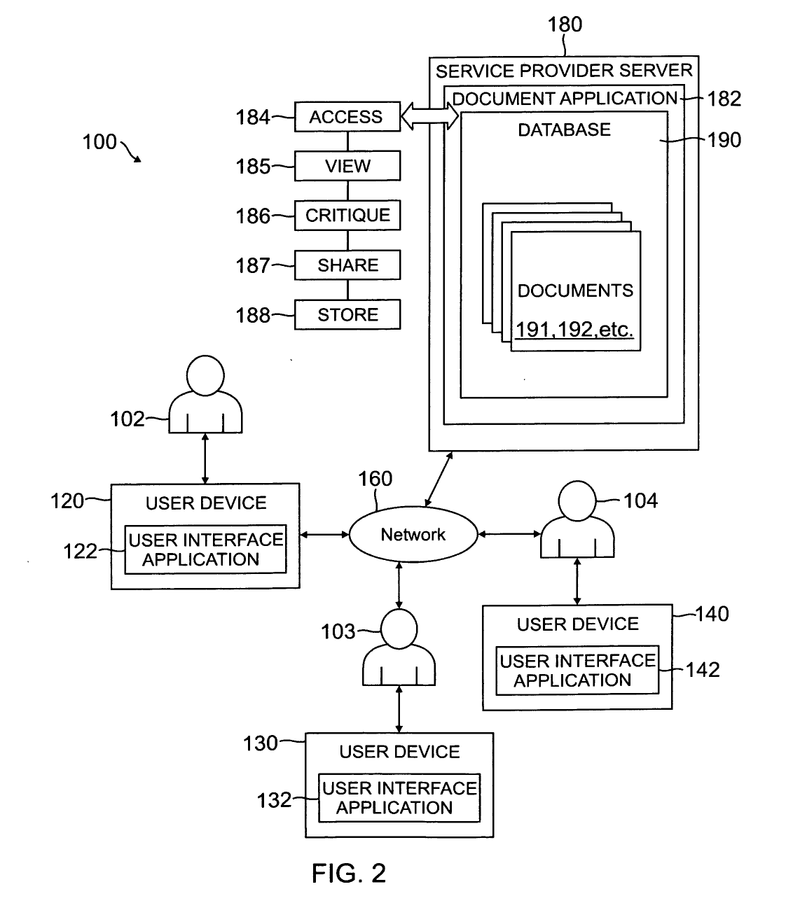

Although the system and methods for document critique includes elements such as a document application and a critique module, as well as corresponding tools, features, and functionality of each element are described herein and shown in FIGS. 2-10 as they relate to a document “online”, it is understood by those skilled the art that the scope and spirit of the system and methods apply equally to any stand alone electronic device such as a desktop or laptop computer, PDA, smart phone, etc., having some data processing functionality. In this regard, the term “online” means connectivity to a “network” as the term “network” is described below.

In one embodiment the subject matter described herein provides for a robust easy to use system and method for, among other things, the critique of one or more documents online. As shown in FIG. 2, the system 100 includes at least one user device 120, 130, 140, etc., (e.g., network computing device) and at least one service provider server 180 (e.g., network server device), in communication over a network 160.

The network 160 may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, the at least one client device 120, 130, 140, etc., and the at least one service provider server 180 may be associated with a particular link (e.g., a link, such as a URL (Uniform Resource Locator) to an IP (Internet Protocol) address.

In one embodiment, the service provider server 180 may be maintained by an online service provider and/or entity in communication with the network 160. As such, the service provider server 180 may be implemented using any appropriate combination of hardware and/or software configured for wired and/or wireless communication over the network 160. In one implementation, the service provider server 180 may be implemented as a network computing device (e.g., a network server) in wired and/or wireless communication with the network 160.

As further shown in FIG. 2, the service provider server 180 includes a document application 182, which may be configured to interact with the one or more client devices 120, 130, 140, etc., to facilitate the access of documents 191, 192, etc. stored in a database 190, as well as viewing, critique, and sharing of documents 191, 192, etc., by one or more of the client devices 120, 130, 140 over the network 160.

In one embodiment, the document application 182 utilizes an access module 184, a viewing module 185, a critique module 186, a sharing module 187, and a storing module 188 running on a standard web browser such that documents 191, 192, etc., regardless of document type (doc, docx, HTML, RTF, PDF, etc.) may be accessed, viewed, critiqued, stored, and shared over the network 160. As described in greater detail below, the modules 184-187 enable users, such as user 102, to access, view, critique, and share documents 191, 192, etc. with other users 103, 104 via the network 160. In one example, the access, view, critique, share, and store modules 184-188 may each be implemented within a standard web browser for interfacing with the user 102, or they may be packaged/integrated together in a single application module and implemented within a standard web browser for interfacing with the user 102.

In various embodiments, the at least one user device 120 may be implemented using any appropriate combination of hardware and/or software configured for wired and/or wireless communication over the network 160. The user device 120 may be implemented as a personal computing device (e.g., a personal computer (PC)) in communication with the network 160, such as the Internet. In various other implementations, the user device 120 may be implemented as one or more wireless telephones (e.g., cell phones), personal digital assistant (PDAs), notebook computer, and/or various other generally known types of wired and/or wireless computing devices. It should be appreciated that the user device 120 may be referred to as a client device or a customer device without departing from the scope of the present disclosure.

In one embodiment, the user device 120 includes a user interface application 122 that may be utilized by the user 102 to facilitate communication with the service provider server 180 over the network 160. For example, the user interface application 122 may be implemented to access, view, critique, share, and store a document online via the network 160.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160.

The system 100 may further include multiple users 103, 104, similar to user 102, each having an associated user device 130, 140 that includes a corresponding user interface application 132, 142 connected to the network. In this regard, multiple users 102-104 may simultaneously access, view, critique, and share a single document or multiple documents stored in the database 190 of the service provider server 180 via the network 160. As such, the system and methods described herein is particularly suitable for lectures, group meetings, conferencing, and similar activities that may require simultaneous real-time critique of one or more documents by multiple users. In this regard, the system and methods described herein may offer a tool for teachers and educators.

In various embodiments, the user devices 120, 130, 140 may include other applications as may be desired in one or more implementations to provide additional features available to the users 102-104. In one example, such other applications may include security applications for implementing user-side security features, programmatic user applications for interfacing with appropriate application programming interfaces (APIs) over the network 160 or various other types of generally known programs and/or applications. In other examples, these other applications may interface with the user interface application 122, 132, 142 for improved efficiency and convenience. For example, files, data, and/or various types of information may be imported from multi-media software directly into the user interface application 122, 132, 142 for ease of access to multi-media files (e.g., audio, video, pictures, clip-art, etc.).

The user device 120 may include a user identifier, which may be implemented, for example, as operating system registry entries, cookies associated with the user interface application 122, identifiers associated with hardware of the user device 120, or various other appropriate system identifiers. The user identifier may include attributes related to the user 102, such as personal information (e.g., a user name, password, etc.) that may be associated with one or more of the documents 191, 192, etc., stored in the database 190 of the service provider server 180 for security, access, viewing, and critique privileges that are strictly limited to user 102. In one embodiment, further access, viewing, critique, and sharing of such a document online may be granted to other users 103, 104 with the permission of user 102. The user identifier may be passed to the service provider server 180 during the initial creation of a document or during storage of a preexisting document in the database 190 of the service provider server 180.

As indicated above, the service provider server 180 may be configured to maintain, store and/or archive documents 191, 192, etc., in a database 190, in which each document may include information related to one or more users, such as user 102. As explained in further detail below, in various examples, the documents 191, 192, etc., may include attributes stored as part thereof, and the attributes may be passed to the service provider server 180 as part of the document critique process.

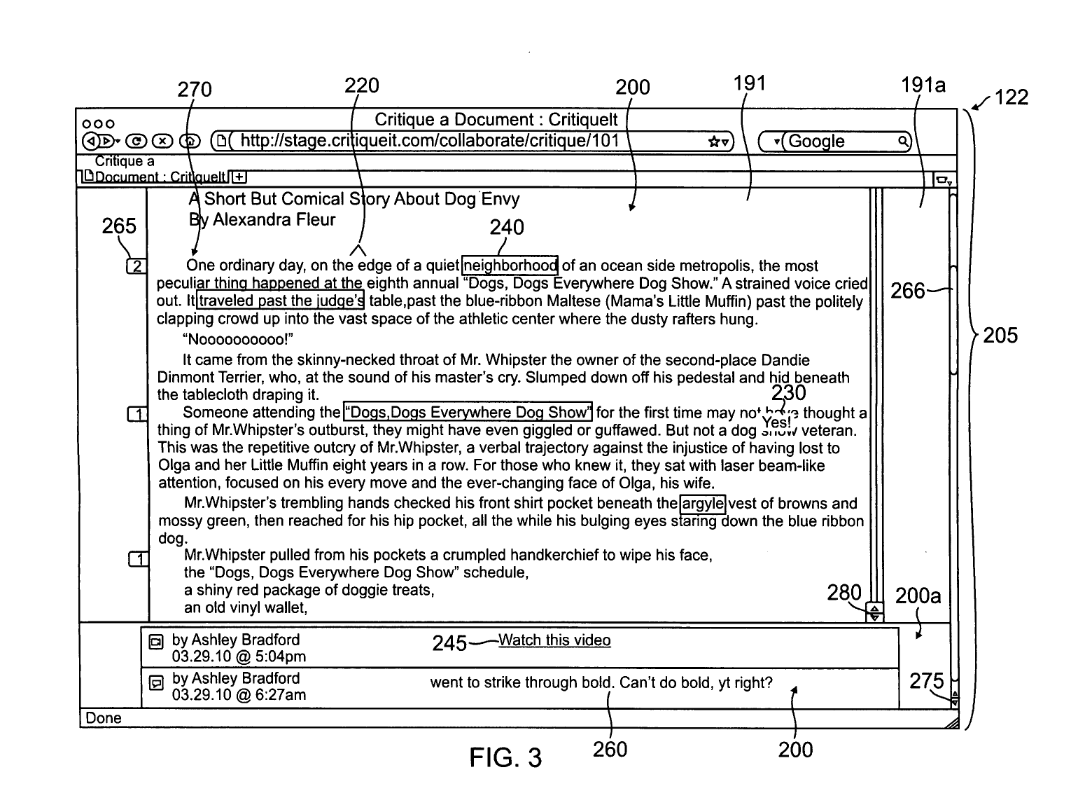

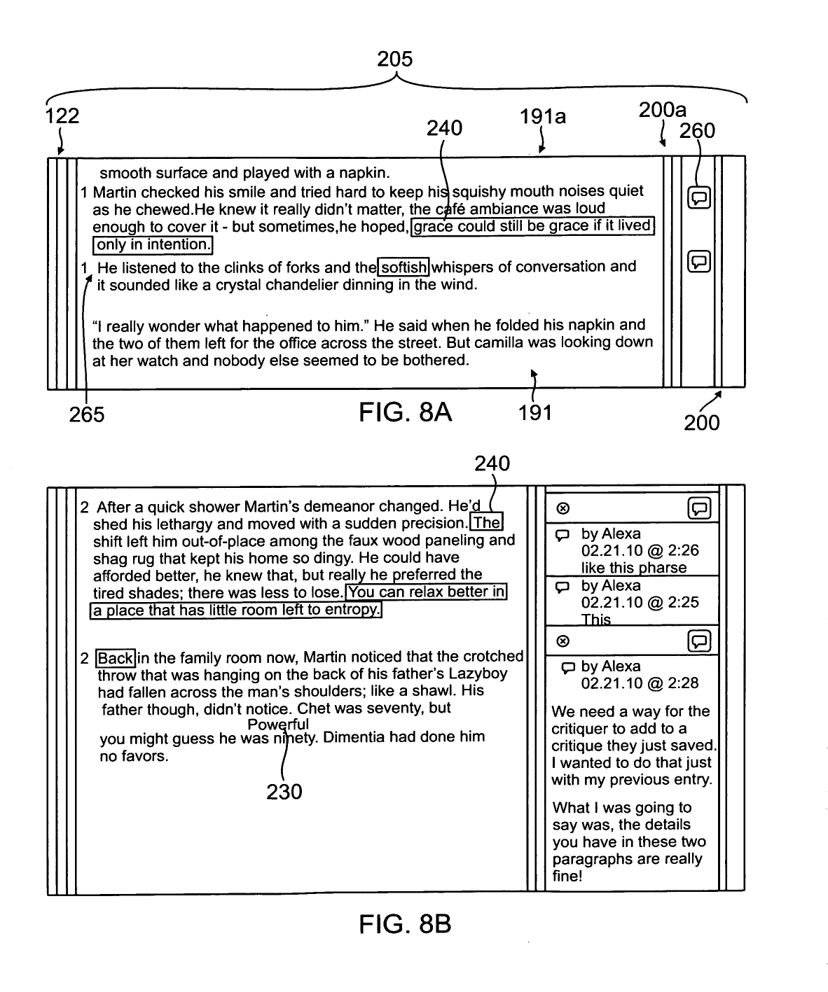

As shown in FIG. 3, the user interface application 122 in communication with the critique module 186 of the document application 182 is able to access and display (view) the corresponding critique tools or features (critique indicators, critique marks, critique elements, etc.) of the critique module 186. The user interface application 122 utilizing a standard web browser and communicating with the service provider server 180 displays a document 191 having a critique indicator 240 within the document and a correspondingly linked critique element 245, 260 along a margin of the document. In this regard, the linked critique element 245, 260 may be positioned along either the right or left margin (FIGS. 8A and 8B), or positioned along the top or bottom margin. For convenience and ease of explanation the critique elements are described and shown in the figures positioned along a bottom margin of the document.

As shown in FIG. 3, the document 191 and the linked critique elements 245, 260 may each be displayed in a separate window of a single-frame split screen 205. In this regard, the separate windows of the single split screen 205 include a document window 191a for viewing the document 191 and a critique window 200a for a critique viewing area 200 having the critique elements 245, 260 disposed therein.

In stark contrast to the vertical or horizontal reviewing pane of the track change edit tool of a known technology in which movement of the document does not illicit a corresponding movement in the reviewing pane, the separate windows 191a, 200a of the single split screen 205 are correlated or synchronized with each other such that when one of the windows 191a, 200a is scrolled the other one of windows 191a, 200a is correspondingly scrolled to permit the linked critiques element 245, 260 to move simultaneously with the related critique indicators 240 and critique marks within the document 191. In this regard, the separate windows 191a, 200a are scrollably synchronized with each other. In other words, when the document 191 in the document window 191a is scrolled up or down the critique window 200a is simultaneously scrolled up or down so that the critique elements 245, 260 and the related critique indicators 240 are viewed at the same time. In the same manner, if the critique window 200a is scrolled up or down the document window 191a is simultaneously scrolled up or down.

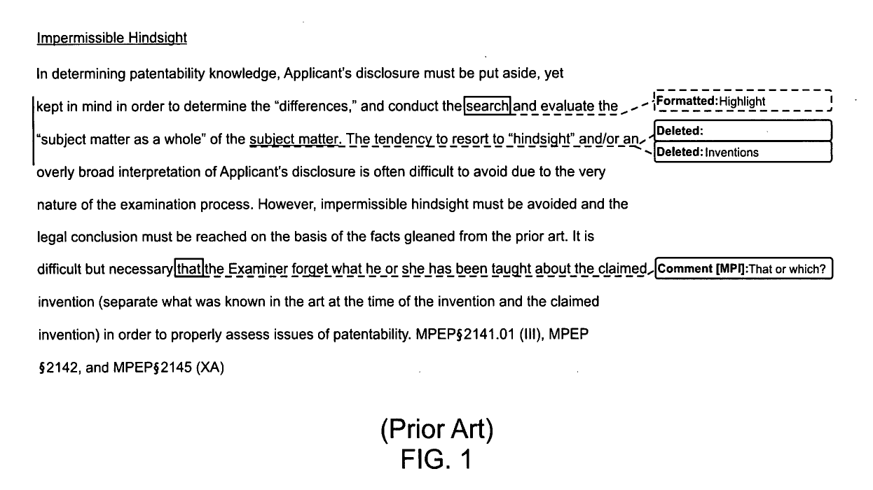

As shown in the embodiment of FIG. 3, the separate windows 191a, 200a of the single-frame split screen 205 may be positioned horizontal one on top of the other. That is, the document 191 may be place above the critique elements 245, 260 or the critique elements 245, 260 may be placed above the document 191. In this regard, the horizontal single-frame split screen 205 overcomes the limitation of the previously mentioned editing application (see FIG. 1) by permitting viewing and critique of the document 191 without reducing the margin width of the document 191.

As mentioned above, the comments and edits, as well as footnotes of the known technology editing application are embedded in or directly connected to the document and move along as the document is scrolled up or down. As the comments and edits are embedded in the document, placement of edits in the right margin of the document reduces the margin width of the not just the document page upon which the edits took place, but the entire document regardless of whether any edits took place on other parts of the document such that the appearance and readability of the entire document is altered dramatically. Furthermore, as the edits, comments, and footnotes are embedded in the document, removal from view of embedded edits comments, or footnotes results in their permanent removal from the document.

In contrast to the known editing application, the critique module 186 of the document application 182 permits: (1) critique of a document 191 such that the content or text of document is not altered as is done with edits of an editing application such as track changes, (2) the separate windows 191a, 200a are scrollably synchronized with each other, and (3) the critique elements 245, 260 described herein are linked to the document 191 such that the critique elements 245, 260 may be hidden from view while the corresponding critique indicator 240 remains visible within the document 191.

In this regard, as used herein, the term “linked” is understood to mean “indirectly associated” such that one item or element of two such items or elements that are “linked” may be removed from view within the viewing interface (screen) while the other item or element of the two such items or elements that are “linked” remains in view within the viewing interface (screen). It is further understood that removing a linked item or element from view within a viewing interface (screen), unless otherwise specified, does not delete or permanently remove the item or element as is done with embedded edits. In other words, the linked item is temporarily hidden from view.

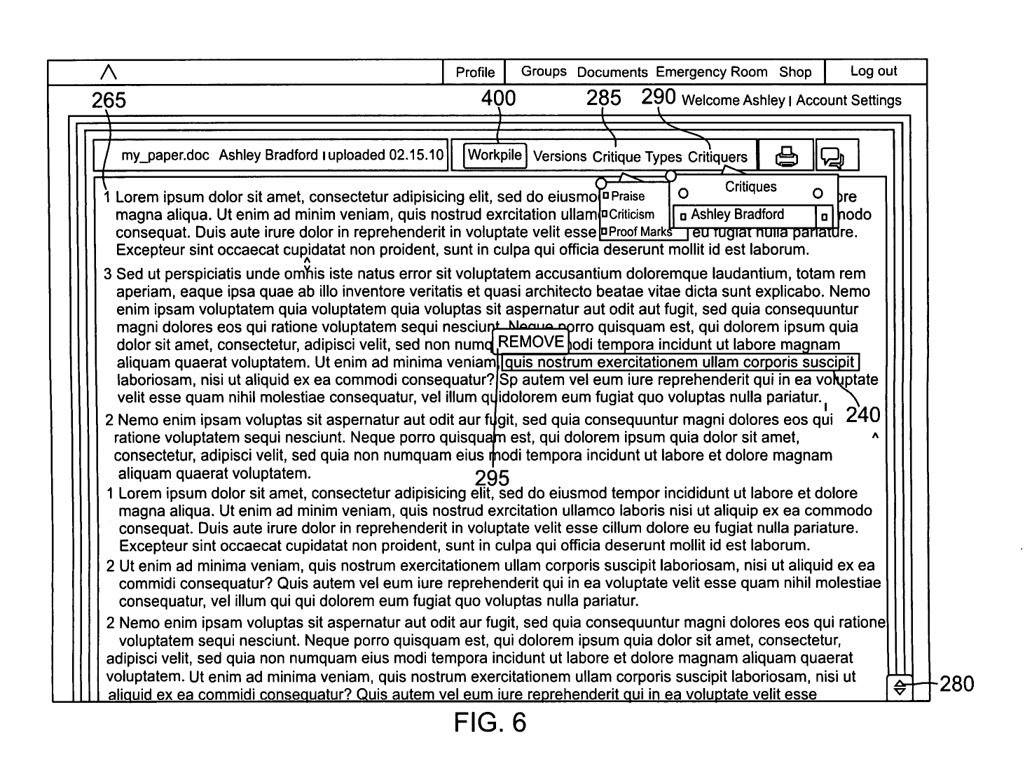

The horizontal single-frame split screen embodiment presents the document 191 including critique marks and video/audio segment 250 and any comment or remark 260 and icon 245 (described below in regard to critique elements) in separate viewing windows 191a, 200a, i.e., screens (split screen 205). As such, the full margin width of the document 191 is maintained and the critique elements 245, 260 appearing in the critique viewing area 200 may be viewable or temporarily hidden from view within the viewing interface (screen) (compare FIG. 3 and FIG. 6) as required by the user.

In this regard, critique elements 245, 260 appearing in the critique viewing area 200 are linked to a critique indicator 240 of the document 191, not embedded in the document as indicated above in regard to edits made by an editing application. The presence of a linked critique element 245, 260 is shown in the viewable document as a critique indicator 240. The critique indicator 240 remains viewable in the document when the critique element 245, 260 or critique window 200a is hidden from view.

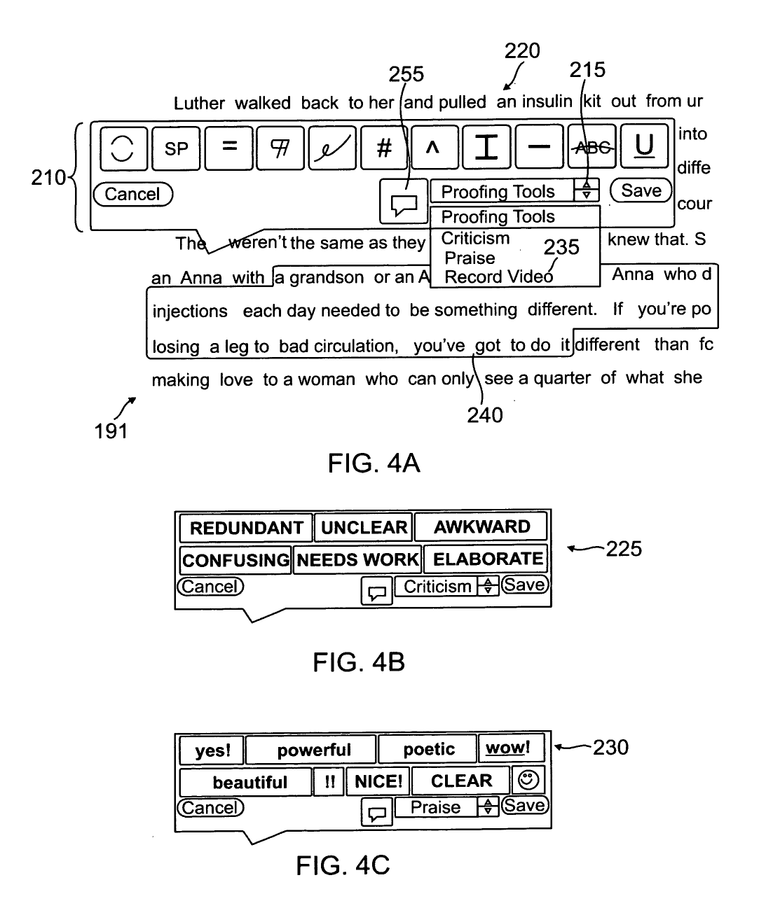

As shown in FIG. 4A, critique of the document 191 may begin by moving a pointing device such as the cursor of a mouse, roller ball, touch pad, etc., to a particular text portion of the document 191 (indicating, for example, by the text “Anna”) and clicking, that is, selecting the text portion to dynamically activate a critique pallet 210 at the point of text selection in the document 191.

As shown in FIGS. 4A-4C, the critique pallet 210 includes a drop down menu 215 that includes individual critique marks/symbols selectable from critique types such as proofing tools 220, criticism 225, and praise 230 for insertion into the document 191 at the same point of text selection as indicated above (see FIG. 3). In this regard, individual critique marks of the proofing tools 220 may include, but are not limited to critique symbols such as spelling or space SP, paragraph ¶, underline U, italicize I, etc. Critique marks of criticism may include, but are not limited to Redundant, Unclear, Awkward, etc. Likewise, critique marks of praise may include but are not limited to Yes!, powerful, Wow!, CLEAR, etc. Prior to selection of any of the critique marks from the proofing tools 220, criticism 225, or praise 230, a critique mark tip or usage box may appear near the critique mark to provide guidance as to proper usage of each critique mark.

In one embodiment, each of the critique marks of the proofing tools 220, criticism 225, and praise 230 are modifiable transparent graphical stamps that permit customization of the critique pallet 210 such that the individual critique marks may be changed to suit the critiquer to permit self-expression and creativity in the critique of documents. The critique pallet 210 may further include graphics such as a smiley face (see FIG. 4C) or hand-written annotation stamps for insertion into the document 191.

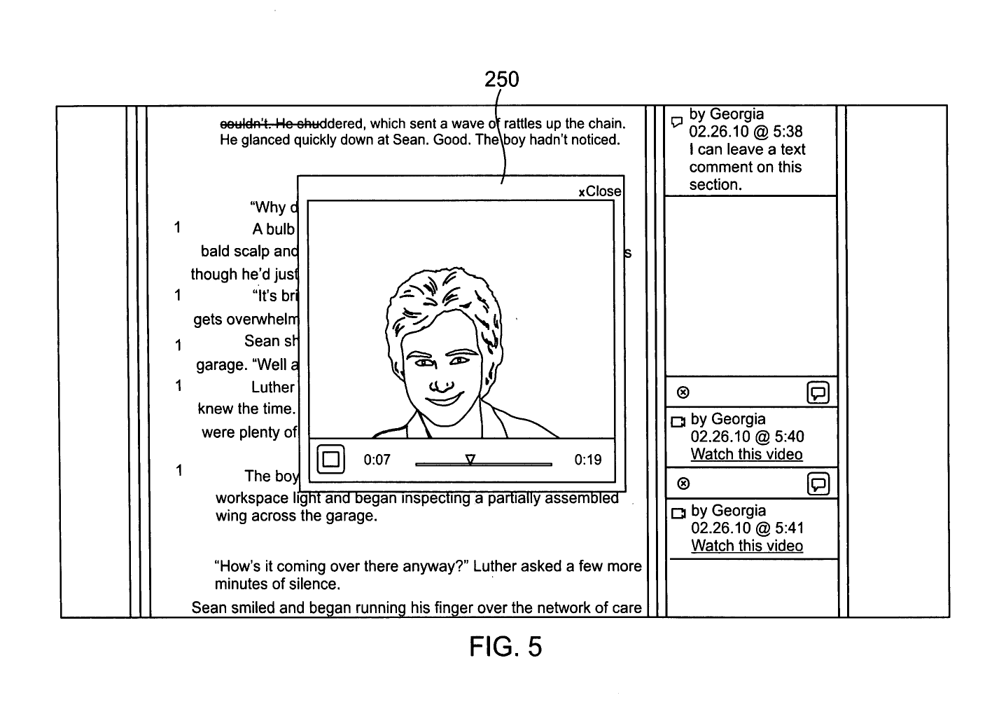

The critique pallet 210 may further include a record video/audio selection mechanism 235 for the insertion of a critique indicator 240 such as a highlighted section of text at the point of text selection indicating the presence of a video/audio segment 250 for play. In this regard, authorization of the critiquer is typically required to enable the record functionality of the critique module 186 of the document application 182. The video/audio segment icon 245 corresponding to the critique indicator 240 appears in the critique viewing area 200 of the horizontal single-frame split screen 205. In this regard, clicking on the critique element 245 (Watch this video icon) as shown in the critique viewing area 200 of FIG. 3 enables the video or audio segment 250 (shown in FIG. 5) corresponding to the critique indicator 240 to play.

The critique pallet 210 may further permit selection of a comment or remarks text box 255 for the insertion of a critique indicator 240 such as a highlighted section of text at the point of text selection in the document 191. As explained in more detail below, critique elements such as comment or remarks 260 corresponding to the critique indicator 240 of the document 191 may appear in the critique viewing area 200 of the horizontal single-frame split screen 205 (see FIG. 3).

The document 191 may include one or more paragraph tab summary markers 265 each positioned along the side of the document 191 next to a corresponding paragraph to indicate the total number of critiques, that is, critique indicators 240 representing comments or remarks 260 and/or video/audio segments 250 contained within the corresponding single paragraph of the document 191.

For example, as shown in FIG. 3, the first, third, and fourth paragraphs of the document 191 contain two critiques, a single critique, and a single critique respectively as shown by the corresponding paragraph tab marker summary 265 next to each paragraph. Individual critique marks of each of the proofing tools 220, criticisms 225, and praises 230 of the critique pallet 210 contained in each paragraph are not accounted for by the paragraph tab summary marker 265 as the critique marks are generally considered self-explanatory.

Clicking on any paragraph tab summary marker 265 will open the critique viewing area 200 and enable critique elements such as comments or remark 260 and/or the audio/video icon 245 to appear in the critique viewing area 200 of a full paragraph. For example, as shown in FIG. 3, the upper most paragraph tab summary marker 265 indicated by the number two next to the first paragraph of the document 191 has been selected and the corresponding two critique elements including one video/audio icon 245 and one comment or remark 260 are shown in the critique viewing area 200 of the horizontal single-frame split screen 205. Once the critique viewing area 200 is opened a number of viewing options are available.

In this regard, the cursor of the pointing device may be positioned over a comment or remark 260 appearing in the critique viewing area 200 and the critique indicator 240 (section of text corresponding to the comment or remark 260) will be highlighted in the document 191. Alternatively, the cursor of the pointing device may be positioned over a critique indicator 240 in the document 191 and a single comment or remark 260 or video/audio icon 245 corresponding to that critique indicator 240 will appear in the critique viewing area 200. Once the cursor of the pointing device is moved away from the position over the critique indicator 240, all comments or remarks and/or video/audio for the paragraph will reappear in critique viewing area 200.

As shown in FIG. 6, critique marks of the proofing tools 220, criticism 225, and praise 230, as well as comment or remarks 260 and video/audio 250 may be removed from the document 191 by moving the cursor of the pointing device over the appropriate critique indicator 240 and clicking on a remove icon 295.

The document application 182 may include a scroll bar 266 that permits the user or critiquer to navigate, that is, move up or down within the document 191. When moving within the document 191 in the up or down direction using the scroll bar 266 different text portions of a paragraph will enter or exit a “hot spot” area 270 to enable corresponding comments or remarks 260 and/or video/audio icon 245 to appear in the critique viewing area 200 of the synchronized scrollable critique window 200a. As navigation within the document continues and the paragraph exits the “hot spot” area 270 a different text portion of a different paragraph may enter the “hot spot” area 270 and the corresponding comments or remarks 260 and/or video/audio icon 245, if any, will replace the previous critique elements of the preceding paragraph in the critique viewing area 200 of the synchronized scrollable critique window 200a. The “hot spot” area 270 may be positioned anywhere in the document 191 to enable viewing of the critique elements 250, 260 of a particular paragraph entering the “hot spot” area 270 to appear in the critique viewing area 200. Similarly, the critique viewing area 200 may include a scroll bar 266 or scroll arrows 275 to permit viewing of a relatively long comment or remark 260.

The document application 182 may include a document resize feature 280 that increases or decreases the size of the document 191. In this regard, for example, when the document resize element 280 of FIG. 3 is enabled the document 191 may be enlarged as shown in FIG. 6. If the document is enlarged significantly, the critique viewing area 200 may be removed from view beneath the document 191. As indicated above, critique elements 245, 260 of the critique viewing area 200 are simply hidden and remain linked to the document 191 as indicated by the appearance of critique indicators 240 even when the critique viewing area 200 is removed from view.

Reducing the size of the document 191 to view the critique viewing area 200 may be accomplished by either selection of the resize feature 280, selection of any one of the paragraph tab summary markers 265, or selection of an individual critique indicator 240 in document 191.

As shown in FIG. 6, the critique module 186 of the document application 182 may include one or more filters such as a critique type filter 285 and a critiquer filter 290. In this regard, upon document critique by a single critiquer or multiple critiquers as indicated above, the document 191 may contain critique marks of the one or more critique types such as proofing tools 220, criticism 225, and praise 230 originating from the critique pallet 210. As such, the critique filter 285 permits the user to temporarily filter, remove, or hide one or more of the critique types and the corresponding critique marks. For example, if the document 191 contains praise 230 and criticism 225 critique marks the user may remove or hide the criticism 225 critique marks so that only the praise 230 critique marks are viewable within the document 191. Once removed, the one or more of the critique types along with the corresponding critique marks may be added back to the document by selecting the appropriate critique type in the critique type filter 285.

Similarly, the critiquer filter 290 permits the critique marks of one or more critiquers to be temporarily removed or hid from view in the document 191. For example, if the document 191 contained critique marks from a first critiquer and a second critiquer, the user may remove all the critique marks of the first critiquer regardless of critique type so that only the critique marks of the second critiquer are viewable in the document 191. The removed critique marks of the first critiquer may be added back into the document 191 by selecting the first critiquer in the critiquer filter 290. It will be understood that the functionality of the critique filter 285 and the critiquer filter 290 may be used alone or in combination such that the critique marks of the first critiquer may be hidden by the critiquer filter 290 while various critique types and corresponding critique marks of the second critiquer may be removed by the critique filter 285.

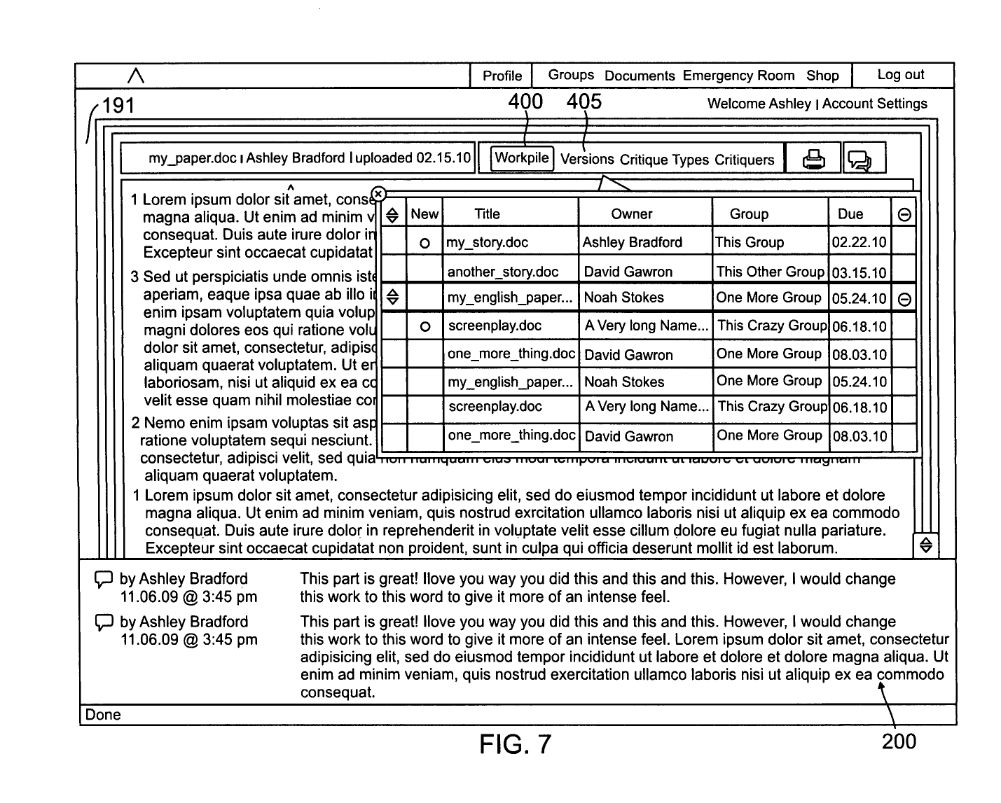

As shown in FIG. 7, the critique module 186 of the document application 182 may further include a workpile tool 400. Once enabled by clicking on the workpile icon a pop-up window containing documents from any group of documents (related by subject matter, class, job, etc.) that were pre-chosen may be selected or queued up for critique. In this regard, documents 191, 192, etc., may be added or removed as needed in the workpile tool 400.

As further shown in FIG. 7, the critique module 186 of document application 182 may further include a document version file 405. Once enabled by clicking on the version file icon, a pop-up window containing, if applicable, one or more versions of the document currently available for critique may be chosen for further critique. In this regard, documents may be added or removed as needed in the document version file 405.

The tools and features described above in regard to FIGS. 2-7 for a system and method of online critique of a document apply equally to the embodiment shown in FIGS. 8A and 8B. In this regard, in accordance with another embodiment, user interface application 122 in communication with the critique module 186 of the document application 182 is able to access and display (view) the corresponding critique tools of the critique module 186. The user interface application 122 utilizing a standard web browser and communicating with the service provider server 180 displays a document 191 for critique and a corresponding critique viewing area 200 each in a separate window (document window 191a for viewing the document 191 and critique window 200a for viewing the critique viewing area 200) of the single-frame split screen 205. As shown in the embodiment of FIGS. 8A and 8B, the separate windows 191a, 200a of the single split-frame screen 2005 are positioned vertically side-by-side to each other.

In contrast to the known editing application detailed herein that includes embedded edit marks within the document, the critique elements 245, 260 of the vertical single-frame split screen embodiment described herein are linked to the document 191 in a separate window with the presence of the linked critique element 245, 260 shown in the document as a critique indicator 240. As the critique elements 245, 260 are linked to the document, the critique indicator 240 remains viewable in the document 191, 192, etc., when the critique viewing area 200 containing the critique elements 245, 260 is removed or hidden from view (for example, see FIG. 6). As such, in the vertical single-frame split screen embodiment only the margin width of a page containing critique elements 245, 260 is reduced, not the entire document.

More specifically, the embodiment of the document application 182 and critique module 186 shown in FIGS. 8A and 8B includes those feature and functionality as described above including the dynamic activation of a critique pallet 210 that includes a drop down menu 215 having critique marks selectable from critique types such as proofing tools 220, criticism 225, praise 230, and record video/video 235 for insertion into the document 191.

The critique pallet 210 may further include a record video/audio selection mechanism 235, text box 255, and critique indicators 240 within the document 191 as a visual cue for the presence of critique elements such as comments or remarks 260 or video/audio 250, while the document 191 may include one or more paragraph tab summary makers 265, “hot spot” areas 270, and one or more scroll bars 266 or scroll arrows 280.

As shown in comparing FIGS. 8A and 8B, the comments or remarks 260 in the critique viewing area 200 may be collapsed (FIG. 8A) or expanded (FIG. 8B) to view the identity of the critiquer, date and time that a critique took place, and the text of the comment or remarks 260 or availability of a video/audio segment 250.

As with the embodiment of FIGS. 2-7, the embodiment shown in FIGS. 8A and 8B, may further include one or more filters such as a critique type filter 285, a critiquer filter 290, as well as a workpile tool 400 and a document version file 405.

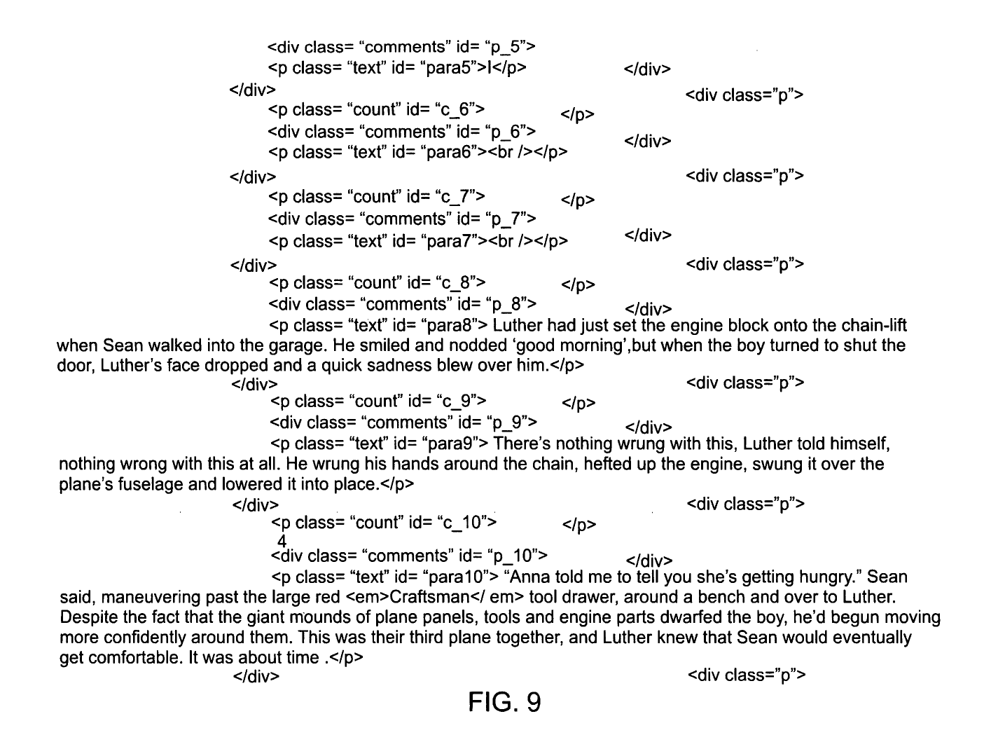

FIG. 9 depicts a counting and conversion mechanism that provides for dynamic placement and analytics. As mentioned above, the user device 120 may include a user identifier or attribute that may be implemented, for example, as operating system registry entries, cookies associated with the user interface application 122, identifiers associated with hardware of the user device 120, or various other appropriate system identifiers. In this regard, identifiers or attributes corresponding to the placement of a keystroke or character entries made during the editing process may be automatically counted and analyzed to determine, for example, how much time and attention each section, portion, or segment of the document receives to permit tracking of statistics of which area of the document has been clicked on, linking of on document graphics to a user specified area of the document, e.g., highlighted area. Essentially, when a document is imported from the database for viewing, each paragraph is marked with a number, and every character is give a number with the corresponding paragraph.

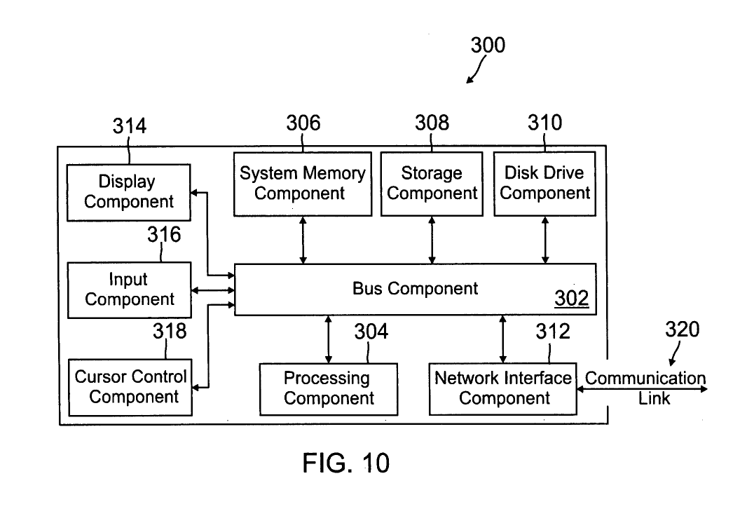

FIG. 10 is a block diagram of a computer system 300 suitable for implementing one or more embodiments of the subject matter disclosure herein, including the user devices 120, 130, and 140, and the service provider device 180. As mentioned above, in various implementations, the user device 120 may comprise a personal computing device capable of communicating with the network 160, such as a personal computer, laptop, cell phone, PDA, etc., and the service provider device 180 may comprise a network computing device, such as a network server. Hence, it should be appreciated that each of the devices 120, 130, 140, 180 may be implemented as computer system 300 in a manner as follows.

In accordance with various embodiments, computer system 300, such as a personal computer and/or a network server, includes a bus 302 or other communication mechanism for communicating information, which interconnects subsystems and components, such as processing component 304 (e.g., processor, micro-controller, digital signal processor (DSP), etc.), system memory component 306 (e.g., RAM), static storage component 308 (e.g., ROM), disk drive component 310 (e.g., magnetic or optical), network interface component 312 (e.g., modem or Ethernet card), display component 314 (e.g., CRT or LCD), input component 316 (e.g., keyboard), and cursor control component 318 (e.g., mouse or trackball). In one implementation, disk drive component 310 may comprise a database having one or more disk drive components.

In accordance with various embodiments disclosed herein, methods are developed as a program language and embodied in a processing of computer-readable medium as executable instructions that can be used to direct a processing program when used by the computer system 300. In this regard, the computer system 300 may perform specific operations by processor 304 executing one or more sequences of one or more instructions contained in system memory component 306. Such instructions may be read into system memory component 306 from a non-transitory type computer readable medium, such as static storage component 308 or disk drive component 310. In other embodiments, hard-wired circuitry may be used in place of or in combination with software instructions to implement the present disclosure.

Logic may be encoded in a non-transitory type computer readable medium, which may generally refer to any medium that participates in providing instructions to processor 304 for execution. Such a medium may take many forms, including but not limited to, non-volatile media, volatile media, and transmission media. In various implementations, non-volatile media includes optical or magnetic disks, such as disk drive component 310, volatile media includes dynamic memory, such as system memory component 306, and transmission media includes coaxial cables, copper wire, and fiber optics, including wires that comprise bus 302. In one example, transmission media may take the form of acoustic or light waves, such as those generated during radio wave and infrared data communications.

Some common forms of non-transitory type computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments described herein, execution of instruction sequences to practice the subject matter of the disclosure may be performed by computer system 300. In various other embodiments, a plurality of computer systems 300 coupled by communication link 320 (e.g., network 160 of FIG. 2, such as a LAN, WLAN, PTSN, cloud server and/or various other wired or wireless networks, including telecommunications, mobile, and cellular phone networks) may perform instruction sequences to practice the present disclosure in coordination with one another.

Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

Where applicable, various embodiments described herein may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, as disclosed herein, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications, whether explicitly described or implied herein, are possible in light of the disclosure. Having thus described embodiments of the present disclosure, persons of ordinary skill in the art will recognize that changes may be made in form and detail without departing from the scope of the present disclosure.

What is claimed is:

1. A document application for the critique of a document, comprising:
a critique module for communication with an interface application for critique and viewing a document having a critique indicator within the document and a correspondingly linked critique element along a margin of the document.

2. The document application of claim 1, wherein the document and the linked critique element are each displayed in a separate window of a single-frame split screen.

3. The document application of claim 2, wherein the separate windows of the single-frame split screen are positioned horizontal one on top of the other such that the full margin width of the viewable document is maintained.

4. The document application of claim 2, wherein the separate windows of the single-frame split screen are positioned vertical side-by-side to each other such that the margin width is reduced only for a page of the document having the critique element.

5. The document application of claim 1, wherein the critique indicator remains viewable within the document when the critique element is hidden from view along the margin of the document.

6. The document application of claim 2, wherein the separate windows are scrollably synchronized with each other.

7. The document application of claim 1, wherein the document further includes a critique mark.

8. The document application of claim 1, wherein the document is critiqued online.

9. A document application for viewing and critique of a document, comprising:
a critique module in communication with an interface application for viewing and critique of a document; wherein the critique module includes:
a critique pallet that dynamically appears in the document at the point of document critique, the critique pallet includes critique marks selectable from critique types that include one of a proofing tool, criticism, or praise for insertion into the document; and
a critique type filter that removes at least one of the critique types from the document.

10. The document application of claim 9, wherein the critique marks are modifiable transparent stamps.

11. A document application for viewing and critique of a document, comprising:
a critique module in communication with an interface application for viewing and critique of a document; wherein the document includes viewable critique marks of multiple critiquers, and wherein the critique module includes:
a critiquer filter for selectable removal of the critique marks of at least one of the multiple critiquers.

12. A system for display and critique of a document, comprising:
a storage device for storage of a document;
a processing element having a processing program and access to the storage device; and
a processing-readable medium having executable instructions thereon to direct the processing system when used by the processing element to display the document for critique, the document having a critique indicator within the document and a correspondingly linked critique element along a margin of the document.

13. The system of claim 12, wherein the document and the linked critique element are each displayed in a separate window of a single-frame split screen.

14. The system of claim 13, wherein the separate windows of the single-frame split screen are positioned horizontal one on top of the other such that the full margin width of the viewable document is maintained.

15. The system of claim 13, wherein the separate windows of the single-frame split screen are positioned vertical side-by-side to each other such that the margin width is reduced only for a page of the document having the critique element.

16. The system of claim 12, wherein the critique indicator remains viewable in the document when the critique element is removed from along the margin of the document.

17. The system of claim 12, wherein display of the document for critique includes a critique pallet having critique marks selectable from critique types that include one of a proofing tool, criticism, or praise for insertion into the document, and a critique type filter that removes or more of the critique types from the document.

18. A computer-readable medium having computer executable instructions thereon to direct a processing system when used by a processing component for performing a method comprising:
displaying a document for critique, wherein the document includes a critique indicator within the document and a correspondingly linked critique element along a margin of the document.

19. The computer-readable medium claim 18, wherein the document and the linked critique element are each displayed in a separate window of a single-frame split screen.

20. The computer-readable medium claim 19, wherein the separate windows of the single-frame split screen are positioned horizontal one on top of the other such that the full margin width of the viewable document is maintained.

21. The computer-readable medium claim 18, wherein the separate windows of the single-frame split screen are positioned vertical side-by-side to each other such that the margin width is reduced only for a page of the document having the critique element.

22. The computer-readable medium of claim 18, wherein the critique indicator remains viewable in the document when the critiqued element is hidden from view along the margin of the document.

23. The computer-readable medium of claim 18, wherein the method of displaying the document for critique further includes:
displaying a critique pallet having selectable critique marks selected from critique types that include one of a proofing tool, criticism, or praise for insertion into the document;
selecting one of the selectable critique marks for insertion into the document;
displaying a selectable critique type filter to remove the selected critique mark from the document; and
selecting the selectable critique type filter to remove the selected critique mark from the document.
